(19) United States
(12) Patent Application Publication
(10) Pub. No.: US 2009/0142617 A1
(43) Pub. Date: Jun. 4, 2009

(54) COMPOSITION FOR FORMING SILICON-ALUMINUM FILM, SILICON-ALUMINUM FILM AND METHOD FOR FORMING THE SAME

(75) Inventors: Yasuaki YOKOYAMA, Tokyo (JP); Michiko Yokoyama, Mie (JP); Naomi Shinoda, Aichi (JP); Risa Yokoyama, Mie (JP); Yasuo Matsuki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, Tokyo (JP)

(21) Appl. No.: 12/364,599

(22) Filed: Feb. 3, 2009

Related U.S. Application Data
(62) Division of application No. 10/542,358, filed on Jul. 14, 2005.

(30) Foreign Application Priority Data
Jan. 17, 2003 (JP) 2003-8933

(51) Int. Cl. B32B 9/00; B05D 5/12; B05D 3/00

(52) U.S. Cl. 428/688; 427/74; 427/553

(57) ABSTRACT

A composition for forming a silicon.aluminum film, containing a silicon compound and an aluminum compound. The silicon.aluminum film is obtained by forming a coating film of the above composition and treating it with heat and/or light.

### REFERENCE TO PRIOR APPLICATIONS

This application is a Divisional application of U.S. application Ser. No. 10/542,358, filed Jul. 14, 2005, now pending; which is a 371 application of PCT/JP03/16579, filed Dec. 24, 2003. This application claims priority to Japan application 2003-008933, filed Jan. 17, 2003.

### FIELD OF THE INVENTION

The present invention relates to a composition for forming a silicon.aluminum film, a silicon.aluminum film and a method of forming the same.

### DESCRIPTION OF THE PRIOR ART

An electrode is formed in a silicon solar cell in order to extract and use power generated by exposure to light. The material of the electrode must satisfy the requirements that there should be no rectification at the interface between silicon and the electrode, it should have no series resistance and its bonding strength should be high in order to extract generated power without a loss as much as possible. From these points of view, Ni, Au, Ag, Ti, Pd and Al are used as electrode materials for silicon solar cells, and Al is particularly preferred as an electrode material which is formed on a p type silicon layer (Advanced Electronics I-3 “Solar Energy Optics, Solar Cell” edited by Yoshihiro Hamakawa and Yukinori Kuwano, the sixth impression of the first edition, Baifukan, pp. 75, Feb. 10, 2000).

However, when an aluminum electrode is directly formed on a silicon layer, so-called “Schottky junction” is formed due to a difference in band gap between silicon and aluminum, thereby making it impossible to avoid a loss when power is extracted.

To solve the above problem, there is proposed a method for adjusting the band gap by forming a silicon.aluminum alloy layer between the silicon layer and the aluminum electrode (S. S. Cohen, G. Gildenblat, M. Ghezzo, D. M. Brown, J. Electroch. Soc., vol. 129, pp. 1335, 1982). To form this silicon.aluminum film, physical vapor deposition such as sputtering, vacuum deposition or ion plating, plasma CVD (Chemical Vapor Deposition), thermal CVD, optical CVD, MOCVD (metal organic CVD) or chemical vapor deposition such as reactive ion plating has been employed (refer to JP-A 2002-175983) (the term “JP-A” as used herein means an “unexamined published Japanese patent application”).

However, these deposition methods, whether they are physical or chemical, involve problems that the apparatus becomes bulky and costly, a particulate deposit and an oxide are readily produced, it is difficult to form a coating film on a large-area substrate and the production cost is high because silicon and aluminum are deposited in a vapor phase.

In the deposition methods, whether they are physical or chemical, as a compound which becomes gaseous in vacuum is used, there are restrictions on the raw material compound and a vacuum apparatus having high airtightness is required, thereby boosting the production cost.

Meanwhile, in various electric circuits, a resistor is used to reduce voltage, divide voltage or generate module heat. Since a plurality of resistors having different electric resistance values must be used according to purpose and installation site, an electric circuit having such resistors has a certain measure of size inevitably and therefore becomes an obstacle to the downsizing of electric equipment.

If any electric resistance can be provided to a wiring material, most of the resistors in the circuit become unnecessary, thereby reducing the size of electric equipment. Although a silicon.aluminum alloy is expected to be promising as such a wiring material, a bulky apparatus is required to form the alloy, thereby boosting the cost. Therefore, studies on the use of the silicon.aluminum alloy in this field are rarely made.

In the above situation, an industrial method of forming a silicon.aluminum film at a low cost without requiring an expensive vacuum apparatus or high-frequency wave generator has been strongly desired.

### SUMMARY OF THE INVENTION

It is an object of the present invention which has been made in view of the above situation to provide a composition for forming a silicon.aluminum film easily at a low cost, a method of forming a silicon.aluminum film from the composition, and a silicon.aluminum film formed by the method without requiring an expensive vacuum apparatus or high-frequency wave generator.

Other objects and advantages of the present invention will become apparent from the following description.

According to the present invention, firstly, the above objects and advantages of the present invention are attained by a composition for forming a silicon.aluminum film, which comprises a silicon compound and an aluminum compound.

Secondly, the above objects and advantages of the present invention are attained by a method of forming a silicon.aluminum film, comprising the steps of forming a coating film of the above composition for forming a silicon.aluminum film on a substrate and treating the film with heat and/or light.

Thirdly, the above objects and advantages of the present invention are attained by a silicon.aluminum film formed by the above method of the present invention.

In the present invention, the term “silicon.aluminum film” means a mixture of silicon and aluminum or an inter-atomic compound.

The present invention will be described in more detail hereinunder.

### BRIEF DESCRIPTION OF THE DRAWING

FIG. 1 shows the ESCA spectrum of a silicon.aluminum film obtained in Example 1.

### DETAILED DESCRIPTION OF THE PREFERRED EMBODIMENT

### Composition for Forming a Silicon.Aluminum Film

The composition for forming a silicon.aluminum film of the present invention comprises a silicon compound and an aluminum compound.

The silicon compound is not limited to a particular kind as far as it can attain the object of the present invention.

For example, compounds represented by the following formulas (1) to (4) are preferred as the silicon compound. They may be used alone or in combination of two or more.

SiₐX₂ₐ₊₂ (2)

wherein X is a hydrogen atom, halogen atom or monovalent organic group and “a” is an integer of 2 or more.

Si_{b}X_{2b} (3)

wherein X is as defined in the above formula (2) and “b” is an integer of 3 or more.

Si_{c}X_{c} (4)

wherein X is as defined in the above formula (2) and “c” is an integer of 6 or more.

SiX₄ (1)

wherein X is as defined in the above formula (2).

Examples of the monovalent organic group include alkyl groups having 1 to 12 carbon atoms, alkenyl groups having 2 to 12 carbon atoms, alkynyl groups and aromatic groups having 6 to 12 carbon atoms.

The compounds represented by the above formulas (1) to (4) include halogenosilane compounds, cyclic silane compounds, chain silane compounds, silane compounds having a spiro structure, polycyclic silane compounds and high molecular weight silane compounds obtained by the exposure of these silane compounds to light.

As illustrative examples of these compounds, the halogenosilane compounds include tetrachlorosilane, tetrabromosilane, hexachlorodisilane, hexabromodisilane, octachlorotrisilane and octabromotrisilane; the cyclic silane compounds include cyclotrisilane, cyclotetrasilane, cyclopentasilane, silylcyclopentasilane, cyclohexasilane, cycloheptasilane and cyclooctasilane; the chain silane compounds include n-pentasilane, iso-pentasilane, neo-pentasilane, n-hexasilane, n-heptasilane, n-octasilane and n-nonasilane; the silane compounds having a spiro structure include 1,1′-bicyclobutasilane, 1,1′-bicyclopentasilane, 1,1′-bicyclohexasilane, 1,1′-bicycloheptasilane, 1,1′-cyclobutasilylcyclopentasilane, 1,1′-cyclobutasilylcyclohexasilane, 1,1′-cyclobutasilylcycloheptasilane, 1,1′-cyclopentasilylcyclohexasilylsilane, 1,1′-cyclopentasilylcycloheptasilane, 1,1′-cyclohexasilylcycloheptasilane, spiro[2,2]pentasilane, spiro[3,3]heptasilane, spiro[4,4]nonasilane, spiro[4,5]decasilane, spiro[4,6]undecasilane, spiro[5,5]undecasilane, spiro[5,6]undecasilane and spiro[6,6]tridecasilane; and the polycyclic silane compounds include hexasilaprisman and octasilacubane.

In the above formulas (1) to (4), X is preferably a hydrogen atom or halogen atom, more preferably a hydrogen atom.

Out of the compounds represented by the above formulas (1) to (4), the halogenosilane compounds, the cyclic silane compounds of the formula (3) and the chain silane compounds of the formula (2) are preferred, and the cyclic silane compounds are more preferred.

Particularly preferred examples of the silane compound include cyclopentasilane, silylcyclopentasilane and cyclohexasilane.

Examples of light which can be used to synthesize the high molecular weight silane compounds by exposure thereto include visible light, ultraviolet light, far ultraviolet light, light from a low-pressure or high-pressure mercury lamp, or deuterium lamp, discharge light from a rare gas such as argon, krypton or xenon, and laser beam from an YAG laser, argon laser, carbon dioxide gas laser or excimer laser such as XeF, XeCl, XeBr, KrF, KrCl, ArF or ArCl. These light sources preferably have an output of 10 to 5,000 W. An output of 100 to 1,000 W is generally satisfactory. The wavelength of the light source is not particularly limited if it is absorbed by the silane compound as a raw material but preferably 170 to 600 nm.

The temperature for carrying out the exposure is preferably room temperature to 300° C. The time duration of the exposure is preferably 0.1 minute to 3 hours, more preferably 0.1 to 30 minutes. The exposure is preferably carried out under a non-oxidizing atmosphere.

The exposure may be carried out in the presence of a suitable solvent. The solvent may be the same as a solvent which will be described as an optional component of the composition of the present invention.

The aluminum compound used in the present invention is not limited to a particular kind as far as it can attain the object of the present invention.

Preferred examples of the aluminum compound include a compound represented by the following formula (5) and a complex of an amine compound and aluminum hydride. They may be used alone or in combination of two or more.

AlY₃ (5)

wherein Y is a hydrogen atom or monovalent organic group.

Examples of the monovalent organic group as Y in the above formula (5) include alkyl groups having 1 to 12 carbon atoms, alkenyls group having 2 to 12 carbon atoms, alkynyl groups and aryl groups having 6 to 12 carbon atoms.

Illustrative examples of the aluminum compound represented by the above formula (5) include trimethylaluminum, triethylaluminum, tri-n-propylaluminum, tricyclopropylaluminum, tri-n-butylaluminum, triisobutylaluminum, tri-t-butylaluminum, tri-2-methylbutylaluminum, tri-n-hexylaluminum, tricyclohexylaluminum, tri(2-ethylhexyl)aluminum, trioctylaluminum, triphenylaluminum, tribenzylaluminum, dimethylphenylaluminum, diethylphenylaluminum, diisobutylaluminum, methyldiphenylaluminum, ethyldiphenylaluminum, isobutyldiphenylaluminum, dimethylaluminum hydride, diethylaluminum hydride, diisobutylaluminum hydride, diphenylaluminum hydride, dimethylmethacrylaluminum, dimethyl(phenylethynyl)aluminum and diphenyl(phenylethynyl)aluminum. These aluminum compounds may be used alone or in combination of two or more.

The above complex of an amine compound and aluminum hydride can be synthesized in accordance with methods disclosed by J. K. Ruff et al., J. Amer. Chem. Soc., vol. 82, pp. 2141, 1960, G. W. Fraser et al., J. Chem. Soc., pp. 3742, 1963 and J. L. Atwood et al., J. Amer. Chem. Soc., vol. 113, pp. 8183, 1991.

The amine compound constituting the complex of an amine compound and aluminum hydride is represented by the following formula (6):

R¹R²R³N (6)

wherein R¹, R² and R³ are each independently a hydrogen atom, alkyl group having 1 to 12 carbon atoms, alkenyl group, alkynyl group, cyclic alkyl group or aryl group.

Examples of R¹, R² and R³ in the above formula (6) include a hydrogen atom, saturated alkyl groups such as methyl group, ethyl group, propyl group, butyl group, pentyl group, hexyl group, heptyl group, octyl group, nonyl group, decyl group, undecyl group and dodecyl group, alkenyl groups having an unsaturated group such as methacryl group, alkynyl groups such as phenylethynyl group, cyclic alkyl groups such as cyclopropyl group, and groups having an aryl group such as phenyl group and benzyl group. These alkyl groups, alkenyl groups and alkynyl groups may be linear, cyclic or branched.

Examples of the amine compound represented by the above formula (6) include ammonia, trimethylamine, triethylamine, tri-n-propylamine, triisopropylamine, tricyclopropylamine, tri-n-butylamine, triisobutylamine, tri-t-butylamine, tri-2-methylbutylamine, tri-n-hexylamine, tricyclohexylamine, tri(2-ethylhexyl)amine, trioctylamine, triphenylamine, tribenzylamine, dimethylphenylamine, diethylphenylamine, diisobutylphenylamine, methyldiphenylamine, ethyldiphenylamine, isobutyldiphenylamine, dimethylamine, diethylamine, di-n-propylamine, diisopropylamine, dicyclopropylamine, di-n-butylamine, diisobutylamine, di-t-butylamine, methylethylamine, methylbutylamine, di-n-hexylamine, dicyclohexylamine, di(2-ethylhexyl)amine, dioctylamine, diphenylamine, dibenzylamine, methylphenylamine, ethylphenylamine, isobutylphenylamine, methylmethacrylamine, methyl(phenylethynyl)amine, phenyl(phenylethynyl)amine, methylamine, ethylamine, n-propylamine, isopropylamine, cyclopropylamine, n-butylamine, isobutylamine, t-butylamine, 2-methylbutylamine, n-hexylamine, cyclohexylamine, 2-ethylhexylamine, octylamine, phenylamine, benzylamine, ethylenediamine, N,N′-dimethylethylenediamine, N,N′-diethylethylenediamine, N,N,N′,N′-tetramethylethylenediamine, N,N,N′,N′-tetraethylethylenediamine, N,N′-diisopropylethylenediamine, N,N′-di-t-butylethylenediamine, N,N′-diphenylethylenediamine, diethylenetriamine, 1,7-dimethyl-1,4,7-triazaheptane, 1,7-diethyl-1,4,7-triazaheptane, triethylenetetramine, phenylenediamine, N,N,N′,N′-tetramethyldiaminobenzene, 1-azabicyclo[2.2.1]heptane, 1-azabicyclo[2.2.2]octane (quinuclidine), 1-azacyclohexane, 1-azacyclohexan-3-ene, N-methyl-1-azacyclohexan-3-ene, morpholine, N-methylmorpholine, N-ethylmorpholine, piperazine and N,N′,N″-trimethyl-1,3,5-triazacyclohexane.

Out of these, ammonia, triethylamine, phenyldimethylamine, triisobutylamine, diisobutylamine, triisopropylamine and triphenylamine are preferred.

These amine compounds may be used alone or in combination of two or more.

The aluminum compound used in the present invention is preferably a complex of an amine compound and aluminum hydride, particularly preferably a complex of triethylamine and aluminum hydride, a complex of ammonia and aluminum hydride, complex of phenyldimethylamine and aluminum hydride, complex of triisobutylamine and aluminum hydride, complex of diisopropylamine and aluminum hydride, complex of triisopropylamine and aluminum hydride or complex of triphenylamine and aluminum hydride.

The ratio of the above silicon compound to the aluminum compound may be suitably set according to the application purpose of a silicon.aluminum film of interest.

For example, to provide semiconductive properties to the formed silicon.aluminum film, the atomic ratio of Al to Si is set to 10⁻⁵ to 10⁻².

To provide conductivity to the formed silicon.aluminum film, the atomic ratio of Al to Si may be set to 0.3 or more. When this value is set to 2 or more, sufficiently high conductivity can be provided to the formed silicon.aluminum film with the result that a silicon.aluminum film suitable for use as a wiring or electrode material is obtained.

The Al/Si ratio of the silicon.aluminum film formed from the composition for forming a silicon.aluminum film of the present invention tends to be larger than the Al/Si ratio of the composition as a raw material. Therefore, the Al/Si ratio of the composition for forming a silicon.aluminum film should be set in consideration of the above experimental tendency.

The composition for forming a silicon.aluminum film of the present invention may contain other components as required in addition to the above silicon compound and aluminum compound.

The other components include metal or semiconductor particles, metal oxide particles and a surfactant.

The above metal or semiconductor particles may be contained to adjust the electric properties of the obtained silicon.aluminum film. At least one selected from the group consisting of gold, silver, copper, aluminum, nickel, iron, niobium, titanium, silicon, indium and tin may be contained. The metal or semiconductor particles preferably have a particle diameter of, for example, about 10 nm to 10 μm. The particles may have any shape such as disk-like, columnar, polygonal or flaky shape besides substantially spherical shape. The content of the metal or semiconductor particles is preferably 30 wt % or less, more preferably 20 wt % or less based on the total amount of the above silicon compound, the aluminum compound and the metal or semiconductor particles.

The above metal oxide particles may be contained to improve the denseness of the film. At least one selected from the group consisting of aluminum oxide, zirconium oxide, titanium oxide and silicon oxide may be contained as an example of the metal oxide particles. The particle diameter and shape of the metal oxide particles are the same as those of the above metal or semiconductor particles, and the content of the metal oxide particles is preferably 10 wt % or less, more preferably 5 wt % or less based on the total amount of the above silicon compound, aluminum compound and metal oxide particles.

The above surfactant may be contained to improve wetness to a substrate to be coated with the composition for forming a silicon.aluminum film of the present invention and the surface smoothness of a coating film and prevent the surface of the coating film from becoming bumpy or citron-like.

The surfactant is a fluorine-based surfactant, silicone-based surfactant or nonionic surfactant.

Examples of the above fluorine-based surfactant include F Top EF301, EF303 and EF352 (of Shin Akita Kasei Co., Ltd.), Megafac F171 and F173 (of Dainippon Ink and Chemicals, Inc.), Asahi Guard AG710 (of Asahi Glass Co., Ltd.), Florado FC-170C, FC430 and FC431 (of Sumitomo 3M Limited), Surflon S-382, SC101, SC102, SC103, SC104, SC105 and SC106 (of Asahi Glass Co., LTd.), BM-1000 and -1100 (of B. M-Chemie Co., Ltd.) and Schsego-Fluor (of Schwegmann Co., Ltd.).

Examples of the above silicone-based surfactant include polymethylsiloxane, copolymer of polymethylsiloxane and oxyethylene, block copolymer of a linear dimethylpolysiloxane-α,ω-dihydro compound and polyethylene glycol monoally ether, and block copolymer of a linear dimethylpolysiloxane-α,ω-dihydro compound, polyethylene glycol/propylene glycol (50/50) copolymer and monoallyl ether.

Examples of the above nonionic surfactant include Emalgen 105, 430, 810 and 920, Leodol SP-40S and TW-L120, Emanol 3199 and 4110, Excel P-40S, Bridge 30, 52, 72 and 92, Arassel 20, Emasol 320, Tween 20 and 60, and Merge 45 (of Kao Corporation), Noniball 55 (of Sanyo Chemical Industries, Ltd.), Chemistat 2500 (of Sanyo Chemical Industries, Ltd.), SN-EX9228 (of San Nopco Co., Ltd.) and Nonal 530 (of Toho Chemical Industry Co., Ltd.).

The content of the surfactant in the composition for forming a silicon.aluminum film of the present invention is preferably 5 wt % or less, more preferably 2 wt % or less based on the total amount of the composition (this contains a solvent when the composition of the present invention contains the solvent as described hereinafter).

The composition for forming a silicon.aluminum film of the present invention may further contain a solvent and is preferably prepared as a solution or suspension.

The solvent which can be used herein is not particularly limited if it dissolves or disperses the above silicon compound and the above aluminum compound and optionally contained other components and does not react with these. It is, for example, a hydrocarbon-based solvent, ether-based solvent or halogen-based solvent.

Examples of the solvent include hydrocarbon-based solvents such as n-pentane, cyclopentane, n-hexane, cyclohexane, n-heptane, cycloheptane, n-octane, cyclooctane, decane, cyclodecane, dicyclopentadiene hydride, benzene, toluene, xylene, durene, indene, tetrahydronaphthalene, decahydronaphthalene and squawalan; ether-based solvents such as diethyl ether, dipropyl ether, dibutyl ether, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, tetrahydrofuran, tetrahydropyran, bis(2-methoxyethyl)ether and p-dioxane; and halogen-based solvents such as methylene chloride and chloroform. These solvents may be used alone or in combination of two or more.

Out of these, hydrocarbon-based solvents and mixtures of a hydrocarbon-based solvent and an ether-based solvent are preferred from the viewpoint of the solubility of the above silicon compound and aluminum compound and the stability of the obtained composition.

When the composition for forming a silicon.aluminum film of the present invention contains a solvent, the solids content (this excludes the solvent from the total amount of the composition) of the composition is preferably 0.1 to 50 wt %, more preferably 0.2 to 30 wt % based on the total amount of the composition.

Before the composition for forming a silicon.aluminum film of the present invention is applied to the substrate, it can be exposed to light. This increases the molecular weight of the silicon compound to improve the coatability of the composition. The same effect is obtained even when the silicon compound alone is exposed to light before it is mixed with the aluminum compound. As light to be applied may be used visible light, ultraviolet light, far ultraviolet light, light from a low-pressure or high-pressure mercury lamp, or deuterium lamp, discharge light from a rare gas such as argon, krypton or xenon, or laser beam from an YAG laser, argon laser, carbon dioxide gas laser or excimer laser such as XeF, XeCl, XeBr, KrF, KrCl, ArF or ArCl. These light sources preferably have an output of 10 to 5,000 W. An output of 100 to 1,000 W is generally satisfactory. The wavelength of the light source is not particularly limited if it is absorbed somewhat by the raw material silane compound but preferably 170 to 600 nm.

The temperature for carrying out the exposure is preferably room temperature to 300° C. The time duration of the exposure is preferably about 0.1 to 30 minutes. The exposure is preferably carried out under a non-oxidizing atmosphere.

### Method of Forming a Silicon.Aluminum Film

The thus obtained composition for forming a silicon.aluminum film of the present invention is applied to the substrate to form a coating film of the composition. Although the material and shape of the substrate are not particularly limited, it preferably can stand the temperature of a heat treatment when the heat treatment is carried out in the subsequent step. The form of the substrate on which the coating film is formed is not particularly limited and may be flat, non-flat with a level difference or cylindrical like a pipe. The material of the substrate is, for example, glass, metal, plastic, ceramic or porcelain. Examples of the glass include quartz glass, boro-silicate glass, soda glass and lead glass. Examples of the metal include gold, silver, copper, nickel, silicon, aluminum, iron and stainless steel. Examples of the plastic include polyimide and polyether sulfone. Further, the form of the material is not particularly limited and may be block-like, plate-like or film-like.

The technique for coating the above composition is not particularly limited and may be spin coating, dip coating, curtain coating, roll coating, spray coating, ink jet coating or printing. The composition may be applied once or a plurality of times.

The preferred thickness of the coating film may be suitably set according to the application purpose of the formed silicon.aluminum film. For instance, when it is used for semiconductors, it is preferably as thick as 50 nm to 100 μm, more preferably 100 nm to 50 μm. When it is used as a conductive film, it is preferably as thick as 10 nm to 20 μm, more preferably 50 nm to 10 μm.

It should be understood that the thickness of the coating film of the composition is a value after the removal of the solvent when the composition for forming a silicon.aluminum film contains the solvent.

The above substrate may be used as a substrate to be pre-coated with a solution containing an organic metal compound comprising a metal atom selected from the group consisting of Ti, Pd and Al so as to form a coating film (primer coat) comprising the organic metal compound thereon. When the substrate has the primer coat, adhesion between the substrate and the silicon.aluminum film is stably maintained.

The organic metal compound comprising a Ti atom is, for example, a titanium alkoxide, titanium compound having an amino group, complex of β-diketone and titanium, titanium compound having a cyclopentadienyl group or titanium compound having a halogen group.

The organic metal compound comprising a Pd atom is, for example, a palladium complex having a halogen group, palladium acetate, complex of β-diketone and palladium, complex of a compound having a conjugated carbonyl group and palladium or phosphine-based Pd complex.

The organic metal compound comprising an Al atom is, for example, an aluminum alkoxide, aluminum alkylate or complex of aluminum and β-diketone excluding a complex of an amine compound and aluminum hydride.

Illustrative examples of the organic metal compound include titanium alkoxides such as titanium methoxide, titanium ethoxide, titanium-n-propoxide, titanium-n-nonyloxide, titanium stearyloxide, titanium isopropoxide, titanium-n-butoxide, titanium isobutoxide, titanium-t-butoxide, titanium tetrakis(bis-2,2-(allyloxymethyl)butoxide, titanium triisostearoyl isopropoxide, titanium trimethylsiloxide, titanium-2-ethylhexoside, titanium methacrylate triisopropoxide, (2-methacryloxyethoxy)triisopropoxy titanate, titanium methoxypropoxide, titanium phenoxide, titanium methylphenoxide, poly(dibutyltitanate), poly(octyleneglycoltitanate), titanium bis(triethanolamine)diisopropoxide, titanium tris(dodecylbenzenesulfonate)isopropoxide, titanium trimethacrylate methoxyethoxy ethoxide, titanium tris(dioctylpyrophosphate)isopropoxide and titanium lactate; titanium compounds having an amino group such as tetrakis(dimethylamino)titanium and tetrakis(diethylamino)titanium; complexes of titanium and β-diketone such as titanium bis(ethylacetoacetate)diisopropoxide, tris(2,2,6,6-tetramethyl-3,5-heptanedionate)titanium, titanium oxide bis(pentanedionate), titanium oxide(tetramethylheptanedionate), titanium methacryloxyacetoacetate triisopropoxide, titanium di-n-butoxide(bis-2,4-pentanedionate), titanium diisopropoxide(bis-2,4-pentanedionate), titanium diisopropoxide bis(tetramethylheptanedionate), titanium diisopropoxide bis(ethylacetoacetate), di(iso-propoxide)bis(2,2,6,6-tetramethyl-3,5-heptanedionate)titanium and titanium allyl acetoacetate triisopropoxide; titanium compounds having a cyclopentadienyl group such as titanocene dichloride, (trimethyl)pentamethylcyclopentadienyl titanium, dimethylbis(t-butylcyclopentadienyl)titanium, biscyclopentadienyltitanium dibromide, cyclopentadienyltitanium trichloride, cyclopentadienyltitanium tribromide, biscyclopentadienyldimethyl titanium, biscyclopentadienyldiethyl titanium, biscyclopentadienyldi-t-butyl titanium, biscyclopentadienylphenyltitanium chloride and biscyclopentadienylmethyltitanium chloride; titanium compounds having a halogen atom such as indenyltitanium trichloride, pentamethylcyclopentadienyltitanium trichloride, pentamethylcyclopentadienyltitanium trimethoxide, trichlorotris(tetrahydrofuran)titanate, tetrachlorobis(tetrahydrofuran)titanium, titanium chloride triisopropoxide, titanium iodide triisopropoxide, titanium dichloride diethoxide, dichlorobis(2,2,6,6-tetramethyl-3,5-heptanedionate) titanium, tetrachlorobis(cyclohexylmercapto)titanium and titanium chloride; palladium complexes having a halogen atom such as palladium chloride, allyl palladium chloride, dichlorobis(acetonitrile)palladium and dichlorobis(benzonitrile)palladium; palladium acetates such as palladium acetate; complexes of palladium and β-diketone such as palladium 2,4-pentanedionate and palladium hexafluoropentanedionate; complexes of palladium and a compound having a conjugated carbonyl group such as bis(dibenzylideneacetone)palladium; phosphine-based Pd complexes such as bis[1,2-bis(diphenylphosphine)ethane]palladium, bis(triphenylphosphine)palladium chloride, bis(triphenylphosphine)palladium acetate, diacetate bis(triphenylphosphine)palladium, dichloro[1,2-bis(diphenylphosphine)ethane]palladium, trans-dichlorobis(tricyclohexylphosphine)palladium, trans-dichlorobis(triphenylphosphine)palladium, trans-dichlorobis(tri-o-tolylphosphine)palladium and tetrakis(triphenylphosphine)palladium; aluminum alkoxides such as aluminum ethoxide, aluminum isopropoxide, aluminum-n-butoxide, aluminum-s-butoxide, aluminum-t-butoxide, aluminum ethoxyethoxyethoxide, aluminum phenoxide and aluminum lactate; aluminum alkylates such as aluminum acetate, aluminum acrylate, aluminum methacrylate and aluminum cyclohexane butyrate; and complexes of aluminum and β-diketone such as aluminum-2,4-pentanedionate, aluminum hexafluoropentanedionate, aluminum-2,2,6,6-tetramethyl-3,5-heptanedionate, aluminum-s-butoxide bis(ethylacetoacetate), aluminum di-s-butoxide ethylacetoacetate and aluminum diisopropoxide ethylacetoacetate.

Out of these, titanium isopropoxide, aluminum isopropoxide, titanium bis(ethylacetoacetate)diisopropoxide, palladium-2,4-pentanedionate, palladium hexafluoropentanedionate, aluminum-2,4-pentanedionate and aluminum hexafluoropentanedionate are preferred.

As the solvent used for the preparation of a solution of the above organic metal compound may be used a solvent which can dissolve the organic metal compound by itself, or a mixture of water and the above solvent. Examples of the solvent include water; ethers such as tetrahydrofuran, dioxane, ethylene glycol dimethyl ether, ethylene glycol diethyl ether, diethylene glycol dimethyl ether and diethylene glycol diethyl ether; esters such as ethylene glycol monomethyl ether acetate, ethylene glycol monoethyl ether acetate, propylene glycol monomethyl ether acetate, propylene glycol monoethyl ether acetate, ethyl acetate and ethyl lactate; alcohols such as methanol, ethanol and propanol; and aprotic polar solvents such as N-methylpyrrolidone, N,N-dimethylformamide, N,N-dimethylacetamide, hexamethyl phosphoamide and γ-butyrolactone. These solvents may be used alone or as a mixed solvent containing water.

The application of the solution of the organic metal compound to the substrate may be carried out by the same coating technique used for the composition of the present invention. The thickness of a coating film (primer coat) is preferably 0.001 to 10 μm, more preferably 0.005 to 1 μm after the removal of the solvent. When the coating film is too thick, the flatness of the film is hardly obtained and when the coating film is too thin, its adhesion to the substrate or the film in contact may become unsatisfactory. The primer coat is formed by applying the above solution and removing the solvent.

The substrate used in the present invention may be a substrate having both a hydrophilic portion and a hydrophobic portion. Thereby, a conductive film can be formed only on a specific portion of the substrate.

The portion corresponding to the hydrophobic portion can be formed by applying a solution containing, for example, hexamethylsilazane and the above fluorine-based surfactant only to the corresponding portion and baking it at 100 to 500° C. To apply the solution containing hexamethylsilazane and the above fluorine-based surfactant only to the above portion, the entire surface of the substrate is made hydrophilic, the required hydrophilic portion is covered, and the above portion is made hydrophobic. Although the method of covering the hydrophilic portion is not particularly limited, for example, a method in which the surface of the substrate is patterned by known photolithography to cover a portion not corresponding to the hydrophobic portion with a known resist and a method in which the above portion is covered with a masking tape, a hydrophobic film is formed in that portion and the used resist or masking tape is removed by a known technique may be employed. Alternatively, after the entire surface of the substrate is made hydrophobic similarly, only a specific portion may be made hydrophilic.

The hydrophilic portion of a substrate having both a hydrophobic portion and a hydrophilic portion used in the present invention can be obtained by applying a solution of an organic metal compound comprising a metal atom selected from the group consisting of Ti, Pd or Al to a portion corresponding to the hydrophilic portion of the substrate and drying it.

The same compound as the organic metal compound described for the primer coat may be preferably used as the organic metal compound.

The thus obtained coating film of the composition for forming a silicon.aluminum film of the present invention is treated with heat and/or light to be changed into a silicon.aluminum film.

The temperature of the above heat treatment is preferably 100° C. or higher, more preferably 150 to 500° C. A heating time of 30 seconds to 120 minutes is satisfactory. The atmosphere of the heat treatment is preferably a non-oxidizing atmosphere, more preferably an atmosphere having as low an oxygen concentration as possible. An atmosphere containing hydrogen is preferred because a high-quality film can be obtained when it is heated in that atmosphere. Hydrogen contained in the above atmosphere may be prepared as a mixed gas containing nitrogen, helium or argon.

The silicon.aluminum film may also be formed by exposing the coating film of the composition for forming a silicon.aluminum film to light. For this optical treatment, for example, a low-pressure or high-pressure mercury lamp, deuterium lamp, discharge lamp of a rare gas such as argon, krypton or xenon, YAG laser, argon laser, carbonic dioxide gas laser, or excimer laser such as XeF, XeCl, XeBr, KrF, KrCl, ArF or ArCl may be used as a light source. These light sources have an output of preferably 10 to 5,000 W. An output of 100 to 1,000 W is generally satisfactory. The wavelength of the light source is not particularly limited but preferably 170 to 600 nm. Use of a laser beam is particularly preferred from the viewpoint of the quality of the formed silicon.aluminum film. The temperature at the time of exposure is preferably room temperature to 200° C. A mask may be used to expose only a specific portion.

The atmosphere for the above exposure may be the same as the atmosphere for the above heat treatment.

When the thus obtained silicon.aluminum film has a high content of aluminum and is left in the air, it is easily oxidized to form an aluminum oxide layer on the surface. Therefore, a problem may arise when the silicon.aluminum film of the present invention is used as a conductive film. To prevent this oxidation, after the conductive film is formed, a protective film may be formed on the surface by applying a solution for forming the protective film in an inert gas atmosphere and evaporating the solvent at 50 to 200° C.

The solution for forming the above protective film is generally a solution containing an organic polymer. The polymer used in this solution is not particularly limited. A poly(meth)acrylate such as polymethyl methacrylate, polybutyl methacrylate or polyethyl acrylate, or homopolymer or copolymer thereof such as polystyrene, polybutene, polyvinyl alcohol, polyvinyl acetate or polybutadiene may be used. The solvent used in the polymer solution is a solvent which dissolves the polymer.

When the protective film is formed, its thickness is preferably 0.001 to 10 μm, more preferably 0.01 to 1 μm.

### Silicon.Aluminum Film

The thus obtained silicon.aluminum film may have a suitable thickness according to its application purpose. When it is used for semiconductors, it is preferably as thick as 0.05 to 100 μm, more preferably 0.1 to 50 μm. When it is used as a conductive film, it is preferably as thick as 10 nm to 50 μm, more preferably 50 nm to 20 μm.

The thus obtained silicon.aluminum film of the present invention has an Al/Si ratio which reflects the Al/Si ratio of the composition for forming a silicon.aluminum film and shows electric properties corresponding to that value. For instance, a silicon.aluminum film showing semiconductive properties is obtained by setting the Al/Si atomic ratio to 10⁻⁵ to 10⁻². A conductive silicon.aluminum film is obtained by setting the Al/Si atomic ratio to 1 or more. By adjusting the Al/Si atomic ratio to 1 or more, a conductive film having a desired electric resistance value can be obtained. For example, a silicon.aluminum film which has sufficiently high conductivity and is advantageously used as a wiring or electrode material can be obtained by setting the Al/Si atomic ratio to 7 or more.

The silicon.aluminum film of the present invention can be advantageously used in solar cells and various electric circuits.

### EXAMPLES

The following examples are provided to further illustrate the present invention.

### Synthetic Example 1

### Synthesis of Cyclopentasilane

After the inside of a four-necked flask having an internal capacity of 3 liters and equipped with a thermometer, cooling capacitor, dropping funnel and stirrer was substituted by an argon gas, 1 liter of dry tetrahydrofuran and 18.3 g of metal lithium were fed to the flask, and the resulting mixture was bubbled with the argon gas. 333 g of diphenyldichlorosilane was added to this suspension by the dropping funnel at 0° C. under agitation, and then agitation was further continued for 12 hours at room temperature until the metal lithium was completely gone. The reaction mixture was poured into 5 liters of iced water to precipitate the reaction product. The obtained precipitate was separated by filtration, rinsed well with water, cleaned with cyclohexane and vacuum dried to obtain 140 g of a white solid. 100 g of this white solid and 1,000 ml of dry cyclohexane were fed to a 2-liter flask, 4 g of aluminum chloride was added, and the resulting mixture was bubbled with a dry hydrogen chloride gas at room temperature under agitation for 8 hours. Separately, 40 g of lithium aluminum hydride and 400 ml of diethyl ether were fed to a 3-liter flask, and the above reaction mixture was added in an argon atmosphere under agitation at 0° C. and stirred at the same temperature for 1 hour and further at room temperature for 12 hours. When vacuum distillation was carried out at 70° C. and 10 mmHg after a by-product was removed from the reaction mixture, 10 g of an achromatic liquid was obtained. It was found from the IR, ¹H-NMR, ²⁹Si-NMR and GC-MS spectra that this liquid was cyclopentasilane.

### Preparation Example 1

### Preparation of Silane-Based Coating Solution (I)

2 g of the cyclopentasilane synthesized in the above Synthetic Example 1 was dissolved in 8 g of toluene to prepare a toluene solution containing 20 wt % of cyclopentasilane (to be referred to as “silane-based coating solution (I)” hereinafter).

### Preparation Example 2

### Preparation of Silane-Based Coating Solution (II)

2 g of the cyclopentasilane prepared in the above Synthetic Example 1 was fed to a 10 ml-flask and exposed to light from a 500 W high-pressure mercury lamp in an argon atmosphere under agitation for 20 minutes and diluted with 8 g of toluene to prepare a silane-based coating solution (II) containing 20 wt % of the silane compound.

### Preparation Example 3

### Preparation of Xylene Solution of a Complex of Triethylamine and Aluminum Hydride

An ethyl ether (100 ml) solution containing 20 g of triethylamine was bubbled with a hydrogen chloride gas in a molar amount 5 times that of the solution to carry out a reaction, and the precipitated salt was separated by filtration with a filter, rinsed with 100 ml of ethyl ether and dried to synthesize 24 g of triethylamine hydrochloride. 14 g of the obtained triethylamine hydrochloride was dissolved in 500 ml of tetrahydrofuran, the resulting solution was added dropwise to a suspension of 3.8 g of lithium aluminum hydride and 500 ml of ethyl ether at room temperature in a nitrogen atmosphere over 1 hour, and the reaction was further continued at room temperature for 6 hours. The reaction solution was filtered with a 0.2 μm membrane filter, the filtrate was concentrated in a nitrogen atmosphere, and a salt which separated out during concentration was obtained by filtration with a 0.2 μm membrane filter. Further, 300 ml of xylene was added, the solvent was evaporated in a nitrogen atmosphere to concentrate the solution, and a salt which separated out during concentration was filtered and purified with a 0.2 μm membrane filter again to obtain a 40 wt % xylene solution of the reaction product.

It was confirmed from the IR spectrum and ¹H-NMR spectrum that the obtained reaction product was a complex of triethylamine and alane.

### Example 1

1.51 g of the silane-based coating solution (I) prepared in the above Preparation Example 1 and 3.28 g of the xylene solution of the complex of triethylamine and aluminum hydride prepared in the above Preparation Example 3 were weighed, fed to a sample bottle and stirred fully to prepare a composition for forming a silicon.aluminum film (Al/Si atomic ratio=1.0) containing cyclopentasilane as a silicon compound and the complex of triethylamine and aluminum hydride as an aluminum compound. Thereafter, a glass substrate was immersed in a 10% toluene solution of titanium bis(ethylacetoacetate)diisopropoxide for 1 hour and dried in the air at 100° C. for 30 minutes and at 300° C. for 30 minutes. This glass substrate was spin coated with the above composition for forming a silicon.aluminum film in a nitrogen atmosphere at 1,000 rpm and prebaked at 110° C. immediately to remove the solvent so as to form a 120 nm-thick coating film.

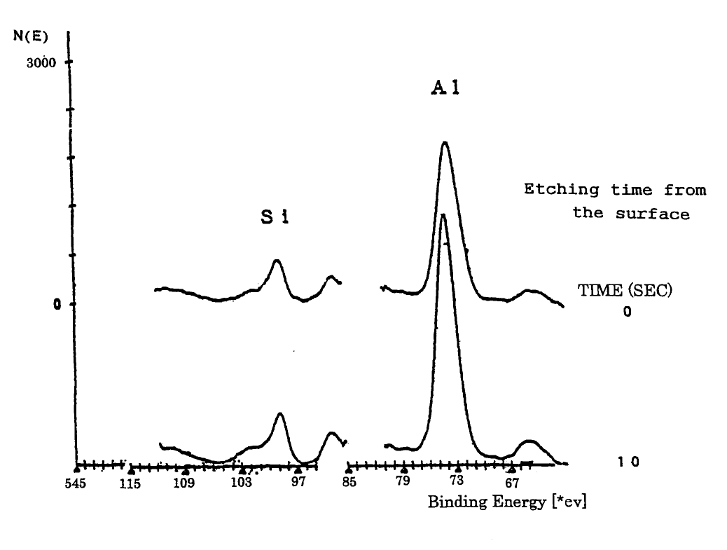

When this coating film was further heated at 100° C. for 30 minutes and 450° C. for 30 minutes in a nitrogen atmosphere, a film having a metallic gloss was formed on the glass substrate. When the thickness of this film on the substrate was measured with αstep (of Tenchor Co., Ltd.), it was 100 nm. The ESCA spectrum of this film is shown in FIG. 1. In FIG. 1, a peak attributed to silicon is seen at 99 eV and a peak attributed to aluminum is seen at 74.9 eV, which means that the obtained film is a silicon.aluminum film containing silicon and aluminum. The Al/Si ratio obtained from ESCA was 3.5 (atomic ratio).

When the surface resistance of this film was measured by the resistivity/sheet resistance measuring instrument (Model RT-80 of Napson Co., Ltd.), it was 3 kΩ/□.

### Example 2

A film having a metallic gloss was formed on a glass substrate in the same manner as in Example 1 except that 200 ml of a toluene solution having a diisobutyl aluminum hydride concentration of 1 mol/l was used in place of 3.28 g of the xylene solution of the complex of triethylamine and aluminum hydride prepared in Preparation Example 3. When the thickness of the film on the substrate was measured with αstep (of Tenchor Co., Ltd.), it was 150 nm. The atomic ratio of Si to Al obtained from ESCA was 4:96 (atomic ratio), which means that the obtained film was a silicon.aluminum film containing silicon and aluminum. The surface resistance of this film was 5 Ω/□.

### Example 3

A composition containing cyclopentasilane and a complex of triethylamine and aluminum hydride was prepared by weighing 1.35 g of the silane-based coating solution (I) prepared in the above Preparation Example 1 and 0.33 g of the xylene solution of the complex of triethylamine and aluminum hydride prepared in the above Preparation Example 3, feeding them to a sample bottle and fully stirring them together in a dry nitrogen atmosphere. A film having a metallic gloss was formed on a glass substrate by using this coating solution in the same manner as in Example 1. When the thickness of this film on the substrate was measured with αstep (of Tenchor Co., Ltd.), it was 130 nm. The Si/Al ratio obtained from ESCA was 97:3 (atomic ratio), which means that the obtained film was a silicon.aluminum film containing silicon and aluminum. The surface resistance of this film was 20 MΩ/□.

### Example 4

A composition containing cyclopentasilane and a complex of triethylamine and aluminum hydride was prepared by weighing 1.15 g of the silane-based coating solution (II) prepared in the above Preparation Example 2 and 3.28 g of the xylene solution of the complex of triethylamine and aluminum hydride prepared in the above Preparation Example 3, feeding them to a sample bottle and fully stirring them together in a dry nitrogen atmosphere. A film having a metallic gloss was formed on a glass substrate in the same manner as in Example 1 except that this coating solution was used. When the thickness of this film on the substrate was measured with αstep (of Tenchor Co., Ltd.), it was 210 nm. The Si/Al ratio obtained from ESCA was 19:81 (atomic ratio), which means that the obtained film was a silicon.aluminum film containing silicon and aluminum. The surface resistance of this film was 1.3 kΩ/□.

### Example 5

A composition containing cyclopentasilane and a complex of triethylamine and aluminum hydride was prepared by weighing 1.35 g of the silane-based coating solution (II) prepared in the above Preparation Example 2 and 0.33 g of the xylene solution of the complex of triethylamine and aluminum hydride prepared in the above Preparation Example 3, feeding them to a sample bottle and fully stirring them together in a dry nitrogen atmosphere. A film having a metallic gloss was formed on a glass substrate in the same manner as in Example 1 except that this coating solution was used. When the thickness of this film on the substrate was measured with αstep (of Tenchor Co., Ltd.), it was 220 nm. The Si/Al ratio obtained from ESCA was 96:4 (atomic ratio), which means that the obtained film was a silicon.aluminum film containing silicon and aluminum. The surface resistance of this film was 1.7 MΩ/□.

As described above, according to the present invention, there are provided a composition for forming a silicon.aluminum film easily at a low cost, a method of forming a silicon.aluminum film from the composition, and a silicon.aluminum film formed by the method without requiring an expensive vacuum apparatus or high-frequency wave generator. The silicon.aluminum film formed by the method of the present invention has electric properties which can be optionally controlled from a semiconductive range to a conductive range and can be advantageously used in solar cells and various electric circuits.

1. A method of forming a silicon.aluminum film, comprising:
forming a coating film comprising a silicon compound and an aluminum compound on a primer coat located on a substrate, said primer coat comprising a metal atom selected from the group consisting of Ti, Pd, and Al; and
treating the coating film with heat and/or light.

2. The method according to claim 1, wherein the silicon compound is at least one selected from the group consisting of compounds represented by the following formulas (1) to (4):
SiₐX₂ₐ₊₂ (1)
wherein X is a hydrogen atom, halogen atom or monovalent organic group and “a” is an integer of 2 or more.
Si_{b}X_{2b} (2)
wherein X is as defined in the above formula (1) and “b” is an integer of 3 or more.
Si_{c}X_{c} (3)
wherein X is as defined in the above formula (1) and “c” is an integer of 6 or more.
SiX₄ (4)
wherein X is as defined in the above formula (1).

3. The method according to claim 1, wherein the aluminum compound is at least one selected from the group consisting of a compound represented by the following formula (5) and a complex of an amine compound and aluminum hydride:
AlY₃ (5)
wherein Y is a hydrogen atom or monovalent organic group.

4. A silicon.aluminum film formed by the method of claim 1.

5. A silicon.aluminum film formed by the method of claim 2.

6. A silicon.aluminum film formed by the method of claim 3.

7. The method according to claim 2, wherein the aluminum compound is at least one selected from the group consisting of a compound represented by the following formula (5) and a complex of an amine compound and aluminum hydride:
AlY₃ (5)
wherein Y is a hydrogen atom or monovalent organic group.

8. The method according to claim 2, wherein the silicon compounds represented by formulas (1) to (4) are at least one selected from the group consisting of halogenosilane compounds, cyclic silane compounds, chain silane compounds, silane compounds having a spiro structure, polycyclic silane compounds, and high molecular weight silane compounds obtained by the exposure of said silane compounds to light.

9. The method according to claim 8, wherein the temperature for carrying out said exposure is from 25 to 300° C. for a time period of from 0.1 minute to 3 hours.

10. The method according to claim 3, wherein the monovalent organic group as Y in the formula (5) is at least one selected from the group of alkyl groups having 1 to 12 carbon atoms, alkenyl groups having 2 to 12 carbon atoms, alkynyl groups having 6 to 12 carbon atoms, and aryl groups having 6 to 12 carbon atoms.

11. The method according to claim 1, wherein the aluminum compound is at least one complex of an amine compound and aluminum hydride wherein the amine compound is at least one selected from the group consisting of ammonia, triethylamine, phenyldimethylamine, triisobutylamine, diisobutylamine, triisopropylamine, and triphenylamine.

12. The method according to claim 3, wherein the amine compound constituting the complex of an amine compound and aluminum hydride is at least one selected from the group consisting of a compounds represented by the following formula (6):
R¹R²R³N (6)
wherein R¹, R², and R³ are each independently a hydrogen atom, alkyl group having 1 to 12 carbon atoms, alkenyl group, alkynyl group, cyclic alkyl group and aryl group.

13. The method according to claim 12, wherein the amine compound represented by formula (6) is at least one selected from the group consisting of ammonia, triethylamine, phenyldimethylamine, triisobutylamine, diisobutylamine, triisopropylamine, and triphenylamine.

14. The method according to claim 1, wherein the atomic ratio of Al to Si is from 10⁻⁵ to 10⁻².

15. The method according to claim 1, wherein the atomic ratio of Al to Si is from 0.3 to 30.

16. The method according to claim 1, wherein the silicon.aluminum film further comprises at least one metal or semiconductor particle selected from the group consisting of gold, silver, copper, aluminum, nickel, iron, niobium, titanium, silicon, indium and tin.

17. The method according to claim 1, wherein the silicon.aluminum film further comprises at least one metal oxide selected from the group consisting of aluminum oxide, zirconium oxide, titanium oxide, and silicon oxide.

18. The method according to claim 1, wherein the silicon.aluminum film further comprises at least one surfactant selected from the group consisting of fluorine-based surfactant, silicone-based surfactant, and nonionic surfactant.

19. The method according to claim 1, wherein the method for forming the silicon.aluminum film further comprises applying a protective film to the silicon.aluminum film.

20. The method according to claim 1, wherein the primer coat is formed by pre-coating the substrate with a solution comprising an organic metal compound wherein the organic metal compound comprises a metal atom selected from the group consisting of Ti, Pd, and Al.
